(19) United States
(12) Patent Application Publication
(10) Pub. No.: US 2006/0062871 A1
(43) Pub. Date: Mar. 23, 2006

(54) Method and system for producing pallet

(75) Inventor: Hiromi Wataya, Kanagawa (JP)

Correspondence Address: GREENBLUM & BERNSTEIN, P.L.C., 1950 ROLAND CLARKE PLACE, RESTON, VA, 20191, US

(73) Assignee: St. Truth Co., Ltd., Kanagawa (JP)

(21) Appl. No.: 10/526,154

(22) PCT Filed: Sep. 6, 2002
(86) PCT No.: PCT/JP02/09091

§ 371 Date: Mar. 1, 2005

(51) Int. Cl. B28B 1/14; A01J 21/00; B29C 39/00; A01J 25/12

(52) U.S. Cl. 425/406; 264/299

(57) ABSTRACT

A method for making pallets in a simple and quick way by evenly heating a base material of pallets is provided. To achieve the above objective, plant fibers are made into unwoven fabric randomly tangled and impregnated with resin to form a sheet of base material. The base material is then sandwiched between upper and lower metal molds, to be heated and pressurized by hot air blowing from hot-air vents at the end of a hot-air channel formed in the metal molds to provide a pallet. Furthermore, a circulation duct may be formed between a hot-air generating means and the hot-air channel made in the metal molds to circulate hot air.

### TECHNICAL FIELD

The present invention relates to an improvement in or relating to a method and apparatus for making pallets for lifting, storing, carrying, loading, and unloading heavy goods, used with a forklift.

### BACKGROUND ART

Among the conventional pallets, wooden pallets are widely used. Such wooden pallets are strong, but are so heavy that they are difficult to handle. The making of massive wooden pallets seriously wastes the forest resources. Furthermore, it is prescribed and required by law that imported timbers be fumigated 8 hours at the temperature of 100° C. to kill harmful insects, resulting in more expenses.

Metal pallets are lighter than wooden pallets, but expensive. Still disadvantageously, they are apt to rust, becoming poor in sanitary condition.

Synthetic resin pallets made of high-density polyethylene or polypropylene do not rust nor corrode, thus remaining in good sanitary condition. Such synthetic resin pallets, however, are not light in weight, and are easy to slide. Still disadvantageously, the resin pallets do not bum well, and thus cannot be easily disposed of Metal molds required in molding resin pallets are very expensive, accordingly requiring a huge amount of investment.

In the hope of solving such problems, the inventor of the present invention has proposed that pallets are made of coconut fibers, which are generally discarded as wastes, and a patent for pallets of coconut fibers has been issued (Japan Patent No. 2778897).

Such pallets of coconut fibers can be made as follows: unwoven fabric, which is made of coconut fibers tangled randomly in all directions, is impregnated with resin and such resin-impregnated unwoven fabric is heated and pressed with a metal mold to be shaped into a pallet. The thermal conductivity of the resin-impregnated unwoven fabric, however, is so low that it may take three to four minutes to make a single pallet when heating the material at the temperature ranging from 200° C. to 230° C.

Further disadvantageously, the temperature of the metal mold is apt to rise higher at the center than its circumference that is cooled by the surrounding atmosphere. Therefore, it is difficult to heat the metal mold evenly, resulting in uneven heating of the material of pallets.

One object of the present invention is to provide a method and apparatus for making pallets of high quality in short time with an increased efficiency.

### SUMMARY OF THE INVENTION

A method for making pallets using plant fibers according to the present invention as defined in claim 1 comprises the steps of preparing unwoven fabric of randomly tangled plant fibers; impregnating the unwoven fabric with resin to provide a sheet of base material; sandwiching and pressurizing the sheet of base material between upper and lower metal molds having a plurality of hot-air vents made throughout their confronting areas; and heating the sheet of base material thus sandwiched by hot air blowing from one to the other metal mold via the hot-air vents to shape the sheet of base material into a pallet with recesses formed on its surface in consequence of the hot-air vents.

In a method for making pallets using plant fibers according to the present invention as defined in claim 2, the randomly tangled plant fibers in claim 1 are prepared by separating the plant fibers from crushed shells of hard-shefled nut-like fruits such as coconut shells and oily coconut shells, or from certain plants such as jute. It is characterized that practically all types of plant fibers can be applied according to the present invention.

An apparatus for making pallets according to claim 3 comprises: upper and lower metal molds confronting each other; a plurality of hot-air vents made throughout confronting areas of both the upper and lower metal molds; and a hot-air generating means having a hot-air outlet and a hot-air inlet to which the hot-air vents of the upper and lower metal molds are connected respectively and vice versa, thereby permitting hot air to circulate and pass through between the upper and lower metal molds to provide a pallet with recesses formed on its surface in consequence of the hot-air vents.

An apparatus for making pallets according to claim 4 comprises additional hot-air vents provided in circumference of the metal molds as described in claim 3.

### BRIEF DESCRIPTION OF THE DRAWINGS

FIG. 1 illustrates an apparatus for making pallets according to one preferred embodiment of the present invention;

FIG. 2 is a perspective view of one example of pallet made according to the present invention;

FIG. 3 is a front view of two pallets of FIG. 1 laid on each other, integrally connected together;

FIG. 4 is a perspective view of another example of pallet made according to the present invention;

FIG. 5 illustrates an apparatus according to another embodiment of the present invention for making flat plate members;

FIG. 6 illustrates an apparatus according to still another embodiment of the present invention for making rod-like members each having a “U”-shape in its cross section; and

FIG. 7 is a side view of a series connection of rod-like members each having a “U”-shape in its cross section.

### DETAILED DESCRIPTION OF THE PREFERRED EMBODIMENT

In making pallets according to the present invention, plant fibers are separated from plant shells of hard-shelled nut-like fruits such as coconuts and oily coconuts, or from certain plants such as jute by using a fiber-separating machine. Thick firm felt-like unwoven fabric is then prepared with the so separated plant fibers randomly tangled. Prior to separating the fibers, the shells of coconuts and oily coconuts are crushed by using a crushing machine and further fragmented as needs arise by using a fragmenting machine.

The unwoven fabric is impregnated evenly with liquid thermosetting resin, such as phenolic resin, acrylic resin, urethane resin, urea resin, melamine resin or resorcinol resin, to provide a sheet of base material. For example, the unwoven fabric of 1.0 to 3.0 kg/m² is impregnated with the liquid thermosetting resin of 10 to 30 weight-percent. Dilution of the liquid thermosetting resin with a solvent such as water or alcohol at the weight ratio of 1:1 to 1:2 makes the viscosity of the resin decrease to the extent that the unwoven fabric may be easily impregnated with the resin.

The unwoven fabric can be impregnated with the resin by spraying it onto the opposite sides of the unwoven fabric with the aid of an increased pressure of air. Otherwise, the unwoven fabric is soaked in the bath of the resin, and then squeezed by sandwiching between upper and lower pressing rolls thereby easily forming the sheet of base material with a required rigidity. The amount of resin-impregnation can be controlled by adjusting the distance between the upper and lower pressing rolls. The strength of the resin-impregnated sheet of base material can be controlled by changing the amount of the solvent or the dilution rate of the resin.

In addition to the thermosetting resins, thermoplastic resin such as vinyl acetate, polypropylene, polyethylene, or olefin resin can be equally used. Pulverized resin can be used too, but liquid resin is easier to evenly impregnate the unwoven fabric.

The resin-impregnated unwoven fabric is then sandwiched between upper and lower metal molds to be heated and pressed as described above to form the sheet of base material.

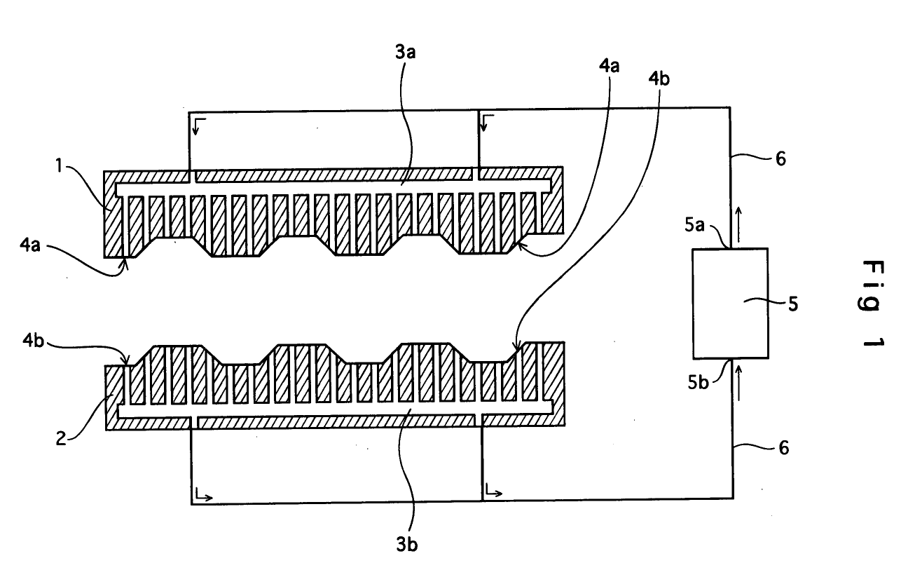

As shown in FIG. 1, the upper metal mold 1 and the lower metal mold 2 have through-holes 3a and 3b respectively, opened to disperse therein. The through-holes 3a and 3b have hot-air vents 4a and 4b respectively on their ends, which are approximately 1 cm in diameter. The hot-air vents 4a and 4b are arranged at the rate of one vent per 5×5 cm² all over confronting surfaces of the upper and lower metal molds 1 and 2 (400 vents over an area of 1×1 m²). Additional hot-air vents 4a and 4b can be provided in the circumference of the metal molds, since this area is cooled by surrounding atmosphere.

The through-holes 3a are connected to a hot-air outlet 5a of a boiler 5 (hot-air generating means) via a conduit 6. Likewise, the through-holes 3b are connected to a hot-air inlet 5b of the boiler 5 via a conduit 6. Hot air generated by the boiler 5 is circulated through the hot-air outlet 5a, the conduit 6, the through-holes 3a, the hot-air vents 4a, the hot-air vents 4b, the through-holes 3b, the conduit 6, and the hot-air inlet 5b in this order so that the hot air passes through the resin-impregnated sheet of base material sandwiched between the upper and lower metal molds 1 and 2. A pallet can be molded in approximately one minute, provided that the upper and lower metal molds 1 and 2 have 10 to 50 kg/cm² of pressurizing force and the boiler 5 generates hot air ranging at the temperature between 180° C. to 200° C.

When the so molded pallet 7 having 1100×1100 mm² in size and 3 to 10 mm in thickness is made from 1.5 to 3.5 kg/m² of unwoven felt-like fabric, the pallet 7 can withstand a load of 10 tons. The pallet 7 further has recesses 8 formed by hot air blown from the hot-air vents 4a onto the confronting surface of the pallet 7. Thus, the pallet 7 has an irregular surface due to the recesses 8, thereby preventing goods from slipping off from the pallet.

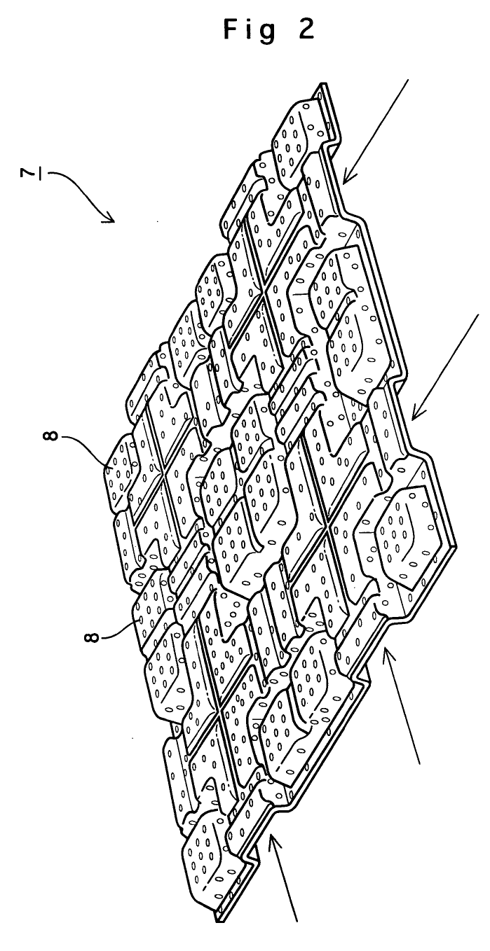

As seen from FIG. 2, a forklift can insert its fork not only from the front but also from the either side of the pallet 7.

It is preferred that plant fibers to be used are obtained from low-cost and abundant resources, such as coconut shells, oily coconut shells, and jute. Harmful insects are often found in such plant fibers, but they can be exterminated during manufacturing process, in which hot air of approximately 180° C. to 200° C. passes through the base material. No extra treatment is therefore required for killing the harmful insects.

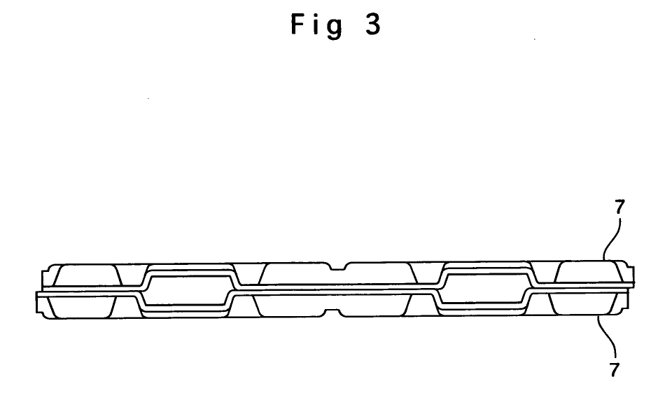

As seen from FIG. 3, two pallets may be laid on each other to be connected as a whole so that the so provided pallet can be reversed for use on either side, permitting a forklift to insert its fork from any of four directions.

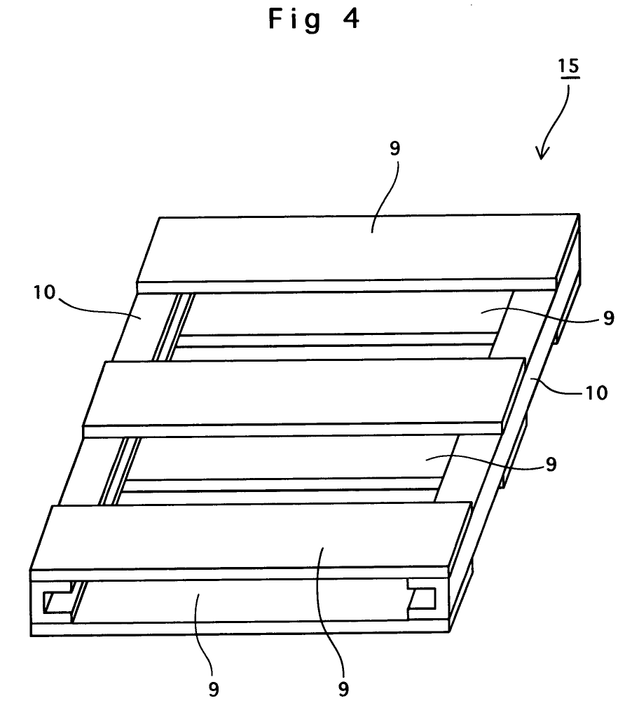

The present invention is not limited to wavy-surfaced pallets as described above. Another example of pallets according to the present invention may comprise flat plate members 9 and rod-like members 10 having a “U”-shape in its cross section as described in FIG. 4.

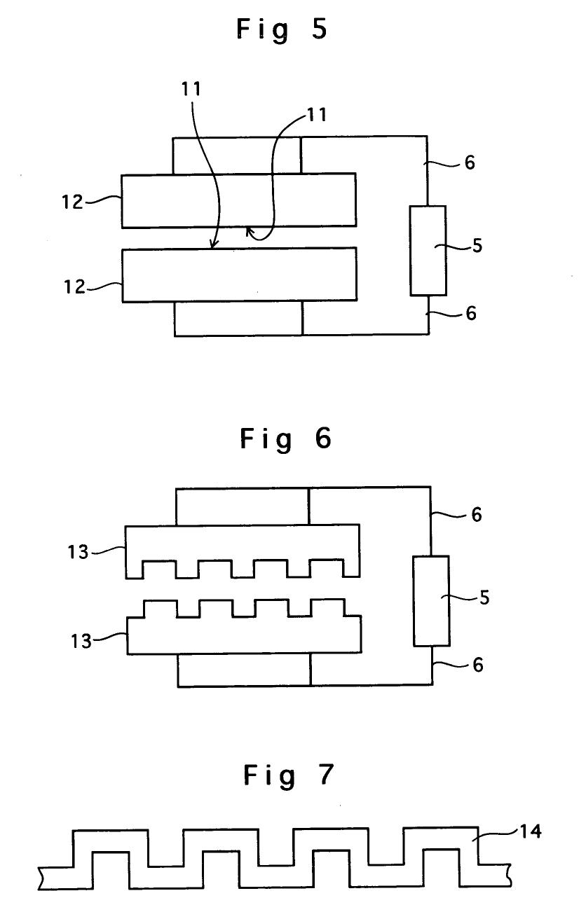

The flat plate members 9 can be formed by using upper and lower metal mold 12 and 12 having flat pressing surface 11 as shown in FIG. 5 (through-holes are omitted as being the same with FIG. 1). A folded board 14 as shown in FIG. 7 can be formed by using upper and lower metal mold 13 and 13 as shown in FIG. 6 (through-holes are omitted as being the same with FIG. 1), and the rod-like members 10 having a “U”-shape in its cross section are cut out from the folded board 14.

The flat plate members 9 and the rod-like members 10 are combined and fastened together by applying adhesive agent or by bolting to provide the pallet as shown in FIG. 4.

This type of pallets needs additional assembly process, but is advantageous in that various sizes of pallets can be made to meet occasional demands.

Industrial Applicability

As mentioned above, the present invention provides a method for making pallets using plant fibers, the method comprising the steps of preparing unwoven fabric of randomly tangles plant fibers; impregnating the unwoven fabric with resin to provide a sheet of base material; sandwiching the sheet of base material between upper and lower metal molds; heating and pressurizing the sheet of base material thus sandwiched by hot air blowing from hot-air vents formed in the metal molds to provide a pallet. Therefore, heat is efficiently conducted through the base material with hot air passing there through, thereby shortening manufacturing time to produce a pallet. Further advantageously, the pallet is formed with recesses on its surface in consequence of the hot-air vents, thereby preventing goods from slipping off from the pallet.

With the present invention as defmed in claim 2, the plant fibers are prepared by separating them from crushed shells of hard-shelled nut-like fruits such as coconut shells and oily coconut shells, or from certain plants such as jute, thereby effectively reducing costs of raw materials.

With the present invention as defined in claim 3, hot air is circulated and reheated, thereby effectively reducing the amount of fuel required for a heat generating means.

With the present invention as defined in claim 4, additional hot-air vents are provided in circumference of said metal molds, thereby permitting an even hardening of resin both in circumference and other parts of the pallet.

1. A method for making pallets from plant fibers comprising the steps of:
preparing unwoven fabric of randomly tangled plant fibers;
impregnating the unwoven fabric with resin to provide a sheet of base material;
sandwiching and pressurizing the sheet of base material between upper and lower metal molds having a plurality of hot-air vents made throughout their confronting areas; and
heating the sheet of base material thus sandwiched by hot air blowing from one to the other metal mold via the hot-air vents to shape the sheet of base material into a pallet with recesses formed on its surface in consequence of the hot-air vents.

2. A method for making pallets according to claim 1, wherein the randomly tangled plant fibers are prepared by separating the plant fibers from crushed shells of hard-shelled nut-like fruits such as coconut shells and oily coconut shells, or from certain plants such as jute.

3. An apparatus for making pallets comprising: upper and lower metal molds confronting each other; a plurality of hot-air vents made throughout confronting areas of both the upper and lower metal molds; and a hot-air generating means having a hot-air outlet and a hot-air inlet to which the hot-air vents of the upper and lower metal molds are connected respectively and vice versa, thereby permitting hot air to circulate and pass through between the upper and lower metal molds via the hot-air vents to provide a pallet with recesses formed on its surface in consequence of the hot-air vents.

4. An apparatus for making pallets according to claim 3, wherein additional hot-air vents are provided in circumference of said metal molds.
